(19) United States
(12) Patent Application Publication
(10) Pub. No.: US 2011/0067488 A1
(43) Pub. Date: Mar. 24, 2011

(54) SYSTEMS AND METHODS FOR REDUCING EXPANSION OF FLUID CONTRAINING TUBES DURING CENTRIFUGATION

(76) Inventors: Robert A. Levine, Guilford, CT (US); Stephen C. Wardlaw, High Rock, CT (US)

(21) Appl. No.: 12/879,984

(22) Filed: Sep. 10, 2010

Related U.S. Application Data
(60) Provisional application No. 61/241,133, filed on Sep. 10, 2009.

(51) Int. Cl. G01N 15/06; B04B 5/02

(52) U.S. Cl. 73/61.71; 494/17

(57) ABSTRACT

Systems and methods for determining the presence of a target material in a suspension are provided. In one embodiment, a system (100) for isolating a target material in suspension includes at least one tube and float system (106,108), an offset fluid (135) disposed with at least one chamber (101-104), and a centrifuge (109) for centrifugally processing the suspension disposed within the at least one tube and float system the at least one chamber.

### CROSS-REFERENCE TO RELATED APPLICATION

This application claims the benefit of Provisional Application No. 61/241,133, filed Sep. 10, 2009.

### TECHNICAL FIELD

The present invention relates to centrifuging tubes.

### BACKGROUND

Tubes containing a suspension are typically centrifuged at high speeds to separate the particles of the suspension into layers according to their respectively specific gravities. High speed centrifugation of a tube containing a suspension creates an outward, radially directed, hydrostatic force on the tube. At the maximum distance from the rotational center of the centrifuge the hydrostatic force is greatest. As the distance from the centrifuge axis decreases, the hydrostatic force decreases linearly but remains substantial throughout most of the tube. The hydrostatic force is often sufficient to expand the diameter of the tube during centrifugation. As the centrifuge slows to a stop, the tube often returns to its pre-expansion size, provided the tube's elastic limit is not exceeded.

While this expansion is normally of little concern in many routine industrial and laboratory procedures, it can be of considerable significance when attempting to identify and isolate rare particles in a suspension. For example, as the tube returns to its pre-expansion size as centrifugation stops, abundant particles in a layer adjacent to a layer containing the rare particles may shift into the rare particle layer preventing identification and isolation of the rare particles.

### SUMMARY

According to an aspect of the present invention, a system for reducing expansion of fluid containing tube and float systems during centrifugation is provided. The system includes at least one chamber and an offset fluid disposed within the at least one chamber. The system includes at least one tube and float system that contains a suspension suspected of having a target material. The at least one tube and float system is disposed within the at least one chamber. The system also includes a centrifuge for centrifugally processing the suspension disposed within the at least one tube and float system. The centrifuge centrifugally spins the at least one tube and float system and the at least one chamber in such a manner that within each chamber the offset fluid surrounds at least a part of the tube and the offset fluid acts on the tube to offset forces that expand the volume of the tube.

### BRIEF DESCRIPTION OF THE DRAWINGS

FIG. 1 shows an isometric view of an example system for isolating a target material of a suspension.

FIG. 2 shows a cross-sectional view along a line A-A, shown in FIG. 1, of an assembly including a tube and float system placed within a chamber filled with an offset fluid.

FIG. 3 shows a flow diagram summarizing a general method of analyzing a suspension for the presence of a target material.

### DETAILED DESCRIPTION

This disclosure is directed to systems and methods for isolating a target material of a suspension. A suspension is a fluid containing particles that are sufficiently large for sedimentation. Examples of suspensions include paint, urine, anticoagulated whole blood, and other bodily fluids. A target material can be cells or particles whose density equilibrates when the suspension is centrifuged. Examples of target materials found in suspensions obtained from living organisms include cancer cells, ova, inflammatory cells, viruses, parasites, and microorganisms, each of which has an associated specific gravity. The system for isolating a target material includes at least one tube and float system, at least one chamber, an offset fluid disposed within each chamber, and a centrifuge for centrifugally processing the suspension disposed within the at least one tube disposed within the at least one chamber.

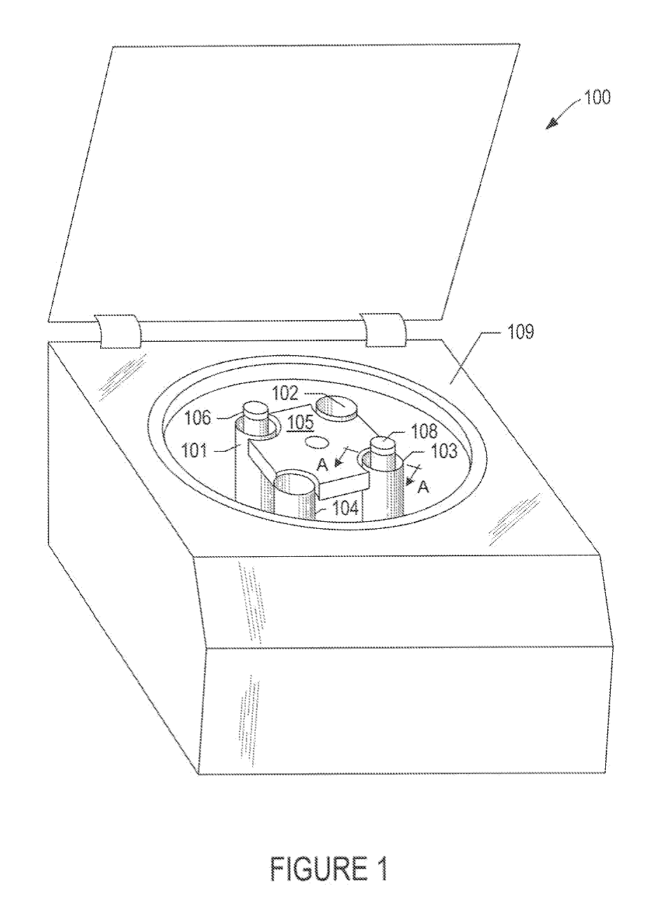

FIG. 1 shows an isometric view of an example system 100 for isolating a target material of a suspension. In the example of FIG. 1, the system 100 includes four chambers 101-104 attached to four slots in a rotor 105, two tube and float systems 106 and 108 are disposed within the chambers 101 and 103, and a centrifuge 109. Each of the chambers 101-104 includes an offset fluid (not shown). Systems for isolating a target material are not limited to just four chambers and two tube and float systems. In other embodiments, the number of chambers can be greater or less than four and each chamber can be dimensioned to include at least one tube and float system.

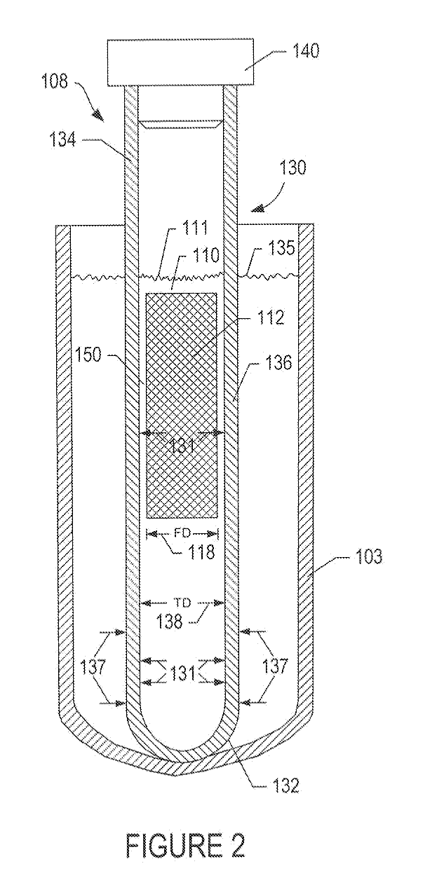

FIG. 2 shows a cross-sectional view along a line A-A, shown in FIG. 1, of an assembly 100 including the tube and float system 108 placed within a chamber 103 filled with an offset fluid 135. The system 108 includes a tube 130 and a float 110, which is shown suspended within a suspension 111. The tube 130 can have a circular cross-section, a first closed end 132, and a second open end 134. The open end 134 is sized to receive a stopper or cap 140, but the open end 134 can also be configured with threads (not shown) to receive a threaded stopper or screw cap 140 that can be screwed onto the open end 134. Other closure means are also contemplated, such as parafilm. The tube 130 can also be configured with two open ends that are both sized and configured to receive stoppers or caps. As shown in the example of FIG. 2, the tube 130 has a generally cylindrical geometry, but may also be configured with a tapered geometry that widens toward the open end 134. Although the tube 134 has a circular cross-section, in other embodiments, the tube 134 can have an elliptical, a square, a rectangular, an octagonal, or any other suitable cross-sectional shape that substantially extends the length of the tube.

The tube 130 is formed of a transparent or semi-transparent material and the sidewall 136 of the tube 130 is sufficiently flexible or deformable such that it expands in the radial direction during centrifugation, e.g., due to the resultant hydrostatic pressure of the sample under centrifugal load. As the centrifugal force is removed, the tube sidewall 136 substantially returns to its original size and shape.

The tube 130 may be formed of any transparent or semi-transparent, flexible material (organic and inorganic), such as polystyrene, polycarbonate, styrene-butadiene-styrene (“SBS”), styrenelbutadiene copolymer, such as K-Resin®. However, the tube 130 does not necessarily have to be clear, as long as the receiving instrument examining the tube 130 for the target material of the suspension can capture images or detect the target material in the tube 130. For example, target materials with a very low level of radioactivity that cannot be detected in a suspension through a non-clear or semi-transparent wall 136 after it is separated by the process of the present invention and trapped between the tube wall 136 and the float 110 as described below.

A variety of different floats can be used for various different analyses, and the present invention is not limited to any particular float. In the example shown in FIG. 2, the float 110 includes a main body portion 112. The float 110 can he composed of one or more generally rigid organic or inorganic materials, such as a rigid plastic material, such as polyoxymethylene (“Delrin®”), polystyrene, aromatic polycarbonates, aromatic polyesters, carboxymethylcellulose, ethyl cellulose, ethylene vinyl acetate copolymers, nylon, polyacetals, polyacetates, polyacrylonitrile and other nitrile resins, polyacrylonitrile-vinyl chloride copolymer, polyamides, aromatic polyamides (aramids), polyamide-imide, polyarylates, polyarylene oxides, polyarylene sulfides, polyarylsulfones, polybenzimidazole, polybutylene terephthalate, polycarbonates, polyester, polyester imides, polyether sulfones, polyetherimides, polyetherketones, polyetheretherketones, polyethylene terephthalate, polyimides, polymethacrylate, polyolefins (e.g., polyethylene, polypropylene), polyallomers, polyoxadiazole, polyparaxylene, polyphenylene oxides (PPO), modified PPOs, polystyrene, polysulfone, fluorine containing polymer such as polytetrafluoroethylene, polyurethane, polyvinyl acetate, polyvinyl alcohol, polyvinyl halides such as polyvinyl chloride, polyvinyl chloride-vinyl acetate copolymer, polyvinyl pyrrolidone, polyvinylidene chloride, specialty polymers, and so forth, and most preferably polystyrene, polycarbonate, polypropylene, acrylonitrile butadiene-styrene copolymer (“ABS”) and others.

In this regard, one of the objectives of the present invention is to avoid the use of materials and/or additives that interfere with the detection or scanning method. For example, if fluorescence is utilized for detection purposes, the material utilized to construct the float 110 does not create “background” fluorescence at the wavelength of interest.

The main body portion 112 of the float 110 is sized to have an outer diameter 118 that is less than the inner diameter 138 of the tube 130. The difference in float outer diameter 118 and the tube inner diameter 138 defines an annular channel or gap 150 between the float 110 outer surface and the inner sidewall 136 of the tube 130. The main body portion 112 occupies much of the cross-sectional area of the tube 130, the annular gap 150 being large enough to contain the target material of the suspension 111.

When the tube and float system 100 is centrifuged, the tube expands, causing the annular gap 150 to increase. As centrifugation is slowed, the annular gap 150 decreases in size returning to its static dimension. As the tube 130 contracts, however, pressure may build up in the fluid located below the float 110. This pressure may cause particles located within the fluid below the float 110 to be forced into the annular gap 150 which contains the target material, thus making imaging or detecting the target material in the annular gap 150 more difficult. Alternatively, the collapse of the side wall 136 of the tube 130 during deceleration may produce excessive or disruptive fluid flow through the expanded layers located within the annular gap 150.

To counteract the radial expansion forces, represented by directional arrows 131, acting on the tube 130, the chamber 103 is at least partially filled with the offset fluid 135. In certain embodiments, as shown in the example of FIG. 2, the offset fluid 135 can be filled to approximately the same level as the suspension 111 in the tube 130. In other embodiments, the offset fluid 135 can be filled to a level that is less than the level of the suspension 111 in the tube 130. In still other embodiments, the offset fluid 135 can be filled to a level that is greater than the level of the suspension 111 in the tube 130. In certain embodiments, the offset fluid 135 can be any fluid or gel that has a density substantially equal to the density of the suspension. For example, the offset fluid 135 can be water, oil, silica gel, silica oil, or a saline solution, etc. In other embodiments, the offset fluid 135 has density that is lower than the density of the suspension 111. In still other embodiments, the offset fluid 135 has a density that is greater than the density of the suspension 111. As explained below, during centrifuging, the offset fluid 135 exerts forces 137 that are directed radially inward on the tube 130 offsetting the outward radial forces 131. The forces 137 acting inwardly against the tube 130 are approximately equal to the outward acting forces 131 from the suspension 111 contained within the tube 130 at any point on the tube 130 from the center of rotation.

The appropriate overall specific gravity of the float 110 depends on the application. Suppose, for example, the suspension 111 is a whole blood sample. The specific gravity of the float 110 can be selected with a specific gravity between that of red blood cells (approximately 1.090) and that of plasma (approximately 1.028). The float 110 may be formed of multiple materials having different specific gravities, so long as the composite specific gravity of the float is within the desired range. The specific gravity of the float 110 and the volume of the annular gap 150 may be selected so that some red cells and/or plasma is retained near the ends of the annular gap 150, as well as the bully coat layers. Upon centrifuging, the float 110 occupies the same axial position as the buffy coat layers and target cells. For example, the float 110 can rest on the packed red cell layer and the buffy coat is retained in the narrow annular gap 150 between the float 110 and the inner wall 136 of the tube 130. The expanded buffy coat region can then be examined under illumination and magnification or imaged to identify circulating epithelial cancer or tumor cells or other target materials.

In one embodiment, the density of the float 110 can be selected so that the float 110 is located within the granulocyte layer of the centrifuged blood sample. The granulocytes are located within the buffy coat layer above the packed red-cell layer and have a specific gravity of about 1.08-1.09. In this embodiment, the float 110 is selected with a specific gravity in the range of about 1.08 to about 1.09 such that, upon centrifugation, the float 110 is located within the granulocyte layer. The amount of granulocytes can vary from patient to patient by as much as a factor of about twenty. Therefore, selecting the float specific gravity to substantially match the specific gravity of the granulocyte layer is advantageous because loss of any of the lymphocyte/monocyte layers, which are located above the granulocyte layer, is avoided. During centrifugation, as the granulocyte layer increases in size, the float 110 may be located higher in the granulocyte layer and keep the lymphocytes and monocytes at essentially the same position with respect to the float 110.

In one example method of using the tube and float system 108, a sample of anticoagulated whole blood is obtained. For example, the whole blood to be analyzed may be drawn using a standard Vacutainer® or other blood collection devices of a type having an anticoagulant predisposed therein.

A fluorescently labeled antibody, which is specific to the target epithelial cells or other target materials, can be added to the blood sample and incubated. In one embodiment, the epithelial cells are labeled with anti-epcam having a fluorescent tag attached to it. Anti-epcam binds to an epithelial cell-specific site that is not typically present in other cells normally found in the blood stream. A stain or colorant, such as acridine orange, may also be added to the whole blood sample to cause the various cell types to assume differential coloration for ease of discerning the buffy coat layers under illumination and to highlight or clarify the morphology of epithelial cells during examination of the sample.

The float 110 may be placed into the tube 130 before or after the blood sample is introduced into the tube 130. The tube and float system 108 filled with the labeled whole blood sample is then placed in the chamber 103 containing the offset fluid 135. When the centrifuging is started, the resultant hydrostatic pressure of the blood sample within the tube 130 and the hydrostatic pressure of the offset fluid 135 offset one another to substantially reduce or prevent radial expansion of the tube wall 136, which typically occurs in the absence of the offset fluid 135 and chamber 103. The blood components and the float 110 are free to move under centrifugal motivation within the tube 130. The blood sample is separated into six distinct layers according to density, which are, from bottom to top: packed red blood cells, reticulocytes, granulocytes, lymphocytes/monocytes, platelets, and plasma. The epithelial cells sought to be imaged tend to also collect in the buffy coat layers, i.e., the granulocyte, lymphocyte/monocyte, and platelet layers as a result of their density. The specific gravity of the float 110 is selected so that it occupies approximately the same axial position as the buffy coat layers. As a result, the contents of the buffy coat are expanded and occupy the narrow annular gap 150.

When the centrifugal separation is complete, and the rotational speed of the tube 130 decreases, the offsetting forces of the blood sample and the offset fluid 135 prevent undesirable fluid flow in the annular region 150 between the float 110 and the tube 130; e.g., the type of fluid flow that typically occurs when the tube 130 was allowed to deform. When the centrifugal force is completely removed, the buffy coat layers and/or other target material are disposed within the annular gap 150 for analysis. Optionally, the tube and float system 100 may be transferred to a microscope or optical reader to identify any target materials in the blood sample.

Once the buffy coat is separated, the tube 130 may be inspected using an automated inspection system for imaging and analysis. This requires precise positioning of the tube. Therefore, features may be added to the sample tube, e.g., to the bottom of the tube, to facilitate tube engagement, handling, and positioning, e.g., under automated or preprogrammed control.

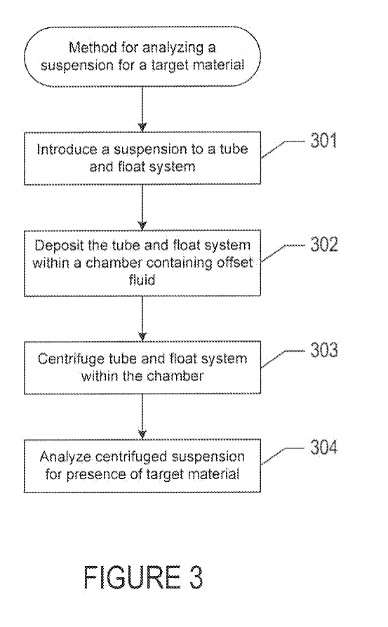

Although system and method embodiments of the present invention have been described for isolating and detecting the presence of target materials in a whole blood sample, embodiments of the present invention are not intended to be so limited. FIG. 3 shows a flow diagram summarizing a general method of analyzing a suspension for the presence of a target material. In step 301, a suspension to be analyzed for the presence of a target material is introduced to a tube and float system. In step 302, the tube and float system containing the suspension are deposited in a chamber containing an offset fluid, as shown in FIG. 2. In step 303, the tube and float system and the chamber including the offset fluid are centrifuged. In step 304, when the time for centrifuging the tube and float system is complete, the tube and float system are removed from the chamber and contents of the layers located within the annular gap 150 are analyzed.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A system (100) comprising:
at least one chamber (101-104);
an offset fluid (135) disposed within the at least one chamber;
at least one tube and float system (106,108) containing a suspension (111), the at least one tube and float system disposed with the at least one chamber; and
a centrifuge (109) for centrifugally processing the suspension disposed within the at least one tube and float system, wherein for each chamber the centrifuge centrifugally spins the tube and float system and the chamber in such a manner that the offset fluid within the chamber surrounds at least a part of the tube and the offset fluid acts on the tube to offset forces that expand the volume of the tube.

2. The system of claim 1, wherein the offset fluid further comprises a density that is substantially equal to the density of the suspension.

3. The system of claim 1, wherein the offset fluid further comprises a density that is greater than the density of the suspension.

4. The system of claim 1, wherein the offset fluid further comprise a density that is less than the density of the suspension.

5. The system of claim 1, wherein the offset fluid is in an amount sufficient to surround the suspension contained within the tube.

6. The system of claim 1, wherein the offset fluid disposed within the at least one chamber further comprises the offset fluid filled to a level less than the level of the suspension contained within the tube.

7. The system of claim 1, wherein the offset fluid disposed within the at least one chamber further comprises the offset fluid filled to a level greater than the level of the suspension contained within the tube.

8. The system of claim 1, wherein the offset fluid disposed within the at least one chamber further comprises the offset fluid filled to a level approximately equal to the level of the suspension contained within the tube.

9. The system of claim 1, wherein the centrifuge further comprises a rotor including at least one slot for receiving the chamber.

10. A method for analyzing a suspension for a target material, the suspension comprising:
introducing (301) the suspension to a tube and float system;
depositing (302) the tube and float system with a chamber containing an offset fluid;
centrifuging (303) the suspension disposed within the tube and the chamber containing the offset fluid in such a manner that the offset fluid within the chamber surrounds at least a part of the tube and the offset fluid acts on the tube to offset forces that expand the volume of the fluid sample holder; and
analyzing (304) the centrifuged suspension between the tube and float for the presence of the target material.

11. The method of claim 10, wherein the suspension is analyzed for the presence of rare cells.

12. The method of claim 10, wherein the offset fluid further comprises a density that is substantially equal to the density of the suspension.

13. The method of claim 10, wherein the offset fluid further comprises a density that is greater than the density of the suspension.

14. The method of claim 10, wherein the offset fluid further comprise a density that is less than the density of the suspension.

15. The method of claim 10, wherein the offset fluid is provided in an amount sufficient to surround the suspension within the tube.

16. The method of claim 10, wherein the chamber containing the offset fluid further comprises the offset fluid filled to a level below the level of the suspension contained within the tube.

17. The method of claim 10, wherein the chamber containing the offset fluid further comprises the offset fluid filled to a level above the level of the suspension contained within the tube.

18. The method of claim 10, wherein the chamber containing the offset fluid further comprises the offset fluid filled to a level approximately equal to the level of the suspension contained within the tube.
